(19) United States
(12) Patent Application Publication
(10) Pub. No.: US 2025/0222385 A1
(43) Pub. Date: Jul. 10, 2025

(54) FILTER DEVICE FOR FILTERING A FLUID, AND FILTER SYSTEM WITH SUCH A FILTER DEVICE

(71) Applicant: MAHLE International GmbH, Stuttgart (DE)

(72) Inventor: Daniel EBERLE, Stuttgart (DE)

(21) Appl. No.: 19/012,053

(22) Filed: Jan. 7, 2025

(30) Foreign Application Priority Data
Jan. 9, 2024 (DE) 102024100462.2

(51) Int. Cl. B01D 46/24; B01D 39/14; B01D 46/00

(52) U.S. Cl. CPC B01D 46/24; B01D 39/14; B01D 46/0004

(57) ABSTRACT

A filter device for filtering a fluid, in particular air is provided, which has a filter element for filtering particles out of the fluid in the flow path. An filtering effect is obtained over a longer service with a simplified implementation in that the filter device has a cover for inserting and/or replacing the filter element, wherein an electrical conductor is attached to the cover, which comes in contact with the filter element in the closed state .

filter system has such a filter device and an ionizer. A motor vehicle with such a filter device is provided.

### CROSS-REFERENCE TO RELATED APPLICATIONS

This application claims priority from German Patent Application No. 10 2024 100 462.2, filed on Jan. 9, 2024, the entirety of which is hereby incorporated by reference herein.

The present invention relates to a filter device for filtering a fluid, which contains a filter element. The invention also relates to a filter system that has such a filter device and an ionizer. The invention also relates to a motor vehicle that has such a filter device.

Filter elements that are part of filter devices are usually used for filtering fluids. These filter elements normally contain a filter medium that retains particles in the fluid flowing through it, thus filtering the fluid.

EP 3 488 933 A1 discloses such a device for filtering air, for example.

The object of the present invention is to create a better, or at least different, filter device, filter system and motor vehicle with such a filter device, resulting in particular in a more effective filtering, and a simpler implementation.

This is achieved with the subject matter of the independent claims. Various embodiments are the subject matter of the dependent claims.

The present invention is based on the fundamental idea of connecting a filter element in a filter device to an electrical power source, in particular to electrostatically charge the filter element, at a cover for the chamber containing the filter element, such that electrical contact is obtained automatically when the cover is attached, wherein the electrical connection can be interrupted when releasing and/or removing the cover without damaging the filter element. The electrical connection can be used to electrostatically charge the filter element, thus improving the performance and increasing the service life of the filter element. The connection through the cover also results in a simplified implementation and reliable performance. On the whole, a simplified implementation is obtained with an improved filtering effect and increased service life.

The filter device obtained with the invention has a section through which the fluid can flow, also referred to below as a channel section. A flow path for the fluid thus passes through the channel section. The filter element is in the channel section and in the flow path, where it filters the fluid. The filter element contains a filter medium for filtering particles out of the fluid in the flow path. There is an opening in the channel section through which the filter element can be inserted and/or replaced, also referred to below as an insertion opening. The filter element is inserted through the insertion opening into the channel section. This is referred to as the insertion direction. The cover closes the insertion opening. There is a closure device with which the cover can be secured to the channel section or released therefrom, such that it can then be removed from the insertion opening. These two states are referred to below as the closed state and opened state. When closed, the cover is secured to the channel section by the closure device, such that the cover closes the insertion opening. When opened, the cover is released from the channel section, such that it can be removed therefrom. The cover has an inner surface facing the filter element in the closed state. There is an electrical conductor on the inner surface of the cover. This conductor is mechanically coupled to the closure device such that the conductor comes in contact with the filter element in the closed state, thus forming an electrical connection, while in the opened state, the conductor is spaced apart from the filter element such that it can move freely, without damaging the filter medium.

The electrical connection to the filter element obtained with the conductor is advantageously used to electrostatically charge the filter element. In particular, this connection is used to electrostatically charge the filter medium. The filter medium is designed for this. By way of example, the filter medium can be made at least in part from an electrically insulating material that can be electrostatically charged.

The filter medium advantageously contains a pleated filter material through which the flow path passes. In particular, the filter medium can be such a pleated filter material. These pleats can be angled, or preferably transverse, in relation to the insertion direction. Consequently, the gaps between the pleats are also angled, or preferably transverse, to the insertion direction. The conductor is preferably spaced apart from the filter element when the cover is placed on the opening and is moved toward the filter element when closing the closure element, such that it then comes in contact with the filter element. Consequently, it is easy to secure and release the cover without noticeably damaging the filter element. A reliable electrical connection is nevertheless obtained in the closed state.

Basically, any fluid can be filtered with this filter device, in particular by the filter element therein.

This filter device is advantageously used to filter gasses, also referred to in general as “air” herein. The filter medium is specifically designed for this.

The filter element preferably has an electrically conductive layer, which the conductor comes in contact with in the closed state, thus forming an electrical connection. The conductor comes in contact with the conductive layer in the closed state, and is spaced apart therefrom in the opened state, such that it can move freely without damaging the conductive layer. This results in a reliable electrical connection to the filter element. Moreover, the electrical connection to the conductive layer of the filter medium results in an advantageous interaction between the filter medium and particles in the fluid, specifically the air, such that they can be more effectively filtered out. This conductive layer is preferably applied to the filter medium.

The conductive layer can theoretically be any such layer.

Preferred conductive layers contain activated carbon, in particular forming an activated carbon layer. The activated carbon itself filters the fluid, specifically the air. This results in a further improvement of the filtering effect.

Embodiments in which the conductive layer, in particular made of activated carbon, is applied to the filter medium, are advantageous. This reduces pressure losses in the fluid, resulting in a more efficient and compact filter device. It is also easier to manipulate.

The conductive layer, in particular made of activated carbon, is advantageously downstream of the filter medium. The fluid therefore flows first through the filter medium, and subsequently through the conductive layer. This prevents, or at least reduces, clogging of the conductive layer by particles. This results in more efficient filtering, and an increased service life of the filter element.

The conductor can theoretically have any design and/or shape.

By way of example, the conductor can be produced from a metal or alloy, e.g. stainless steel. In particular, the conductor can be composed of a metal or alloy, e.g. stainless steel.

Embodiments in which the conductor has a spring are advantageous. In particular, the conductor can form a spring. The closure device is coupled to the spring such that the spring is pressed against the filter element in the closed state, and released therefrom in the opened state. In particular, in the opened state, the spring can be entirely released therefrom. Consequently, a reliable electrical connection to the filter element is obtained in the closed state, and the in the opened state, the filter element as well as the conductor can be inserted and/or replaced, in particular without damage thereto.

The closure device can have any design.

Embodiments in which the closure device has a latching mechanism are advantageous. The latching mechanism has a latching element on the cover and at least one complementary latching element on the channel section. In the closed state, the latching elements engage with one another. This secures the cover to the channel section and closes the insertion opening. In the opened state, the latching elements are disengaged. The cover can then be removed from the channel section, exposing the insertion opening. The latching element on the cover can pivot about an axis such that it can be pivoted between the closed state and the opened state about this axis. The conductor, in particular the spring, is mechanically connected to the latching element, such that the conductor pivots when the latching element pivots. This results in a particularly simple implementation of the filter device with a reliable electrical connection between the filter element and the conductor.

The latching mechanism can be a clip mechanism. The latching element and at least one complementary latching element are designed for this.

The pivot axis can theoretically run in any direction in relation to the insertion direction.

Variations in which the pivot axis is parallel to the insertion direction in the closed state are preferred. This results in a particularly reliable electrical connection to the filter element in the closed state, and a simplified insertion and/or replacement of the filter element in the opened state.

The conductor, in particular the spring, advantageously has a section that is parallel to the pivot axis and connected to the latching element, also referred to below as the connecting section. The conductor also advantageously has a section that is angled or transverse to the connecting section, also referred to below as the contact section. This is where the conductor comes in contact with the filter element. This means that in the closed state, the conductor comes in contact with the filter element at the contact section. The connecting section and contact section thus form an L-shaped or V-shaped lever that pivots about the pivot axis. The result is a reliable mechanical contact to the filter element in the closed state and a simplified insertion and/or replacement of the filter element in the opened state.

The filter device is preferably part of a system that also contains an ionizer for ionizing the fluid, in particular air, that is to be filtered. This system is also referred to as a filter system. In combination with the ionization of the fluid, the filter element, in particular the filter medium, results in a pronounced filtering of particles over a longer service life, specifically through the electrostatic charging obtained with the conductor.

The filter system therefore contains the filter device. The system also contains a channel comprising the channel section of the filter device. The flow path therefore passes through the channel. The ionizer contains an electrode assembly composed of an electrode and a counter-electrode, between which the voltage forms a corona discharge when in use. The electrode is advantageously a discharge electrode. The flow path passes through the electrode assembly upstream of the filter element. The filter element is connected by the conductor with the same potential to the counter-electrode in the closed state.

The electrode, specifically the discharge electrode, preferably has a negative polarity, e.g. between −5 kV and −15 kV, to obtain the corona discharge when in use.

The filter element can theoretically be connected directly to the counter-electrode by the conductor with the same potential. The counter-electrode could also be connected to the filter element by the conductor through a power source in the filter system with the same potential.

The filter device and/or filter system can be used in numerous applications.

By way of example, the filter device and/or filter system can be used to filter air in an air conditioner.

The filter device and/or filter system, e.g. the air conditioner, can be used in a motor vehicle to filter air supplied to the passenger compartment. This means that the flow path enters the passenger compartment downstream of the filter element.

Other important features and advantages of the invention can be derived from the dependent claims, the drawings, and the descriptions of the drawings.

It is understood that the features specified above and explained below can be used not only in the given combinations, but also in other combinations or in and of themselves, without abandoning the scope of the present invention.

Preferred exemplary embodiments of the invention are shown in the drawings and shall be explained in greater detail below, in which the same reference symbols are used for identical, similar, or functionally identical components.

Therein, schematically:

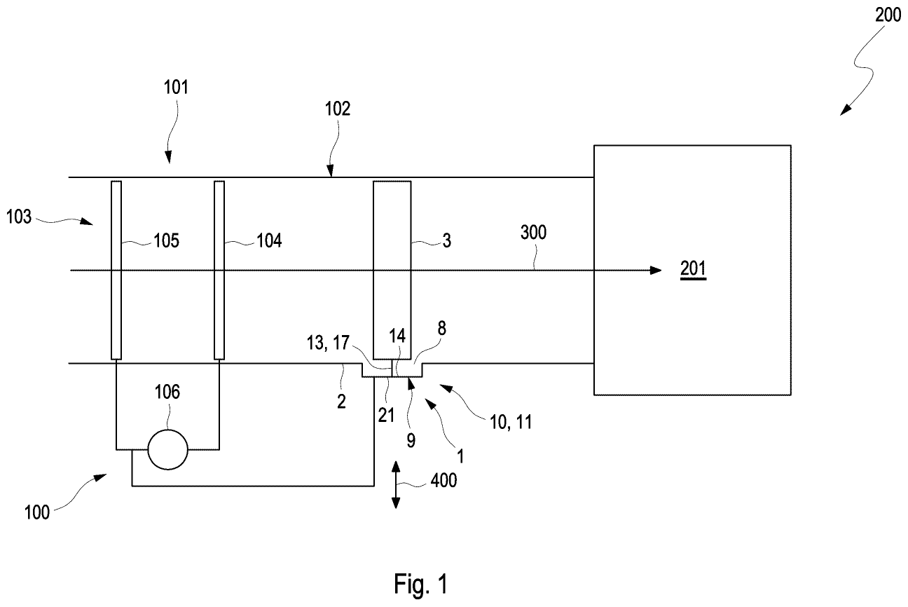

FIG. 1 shows a highly simplified circuit diagram for a filter device in a filter system for a motor vehicle;

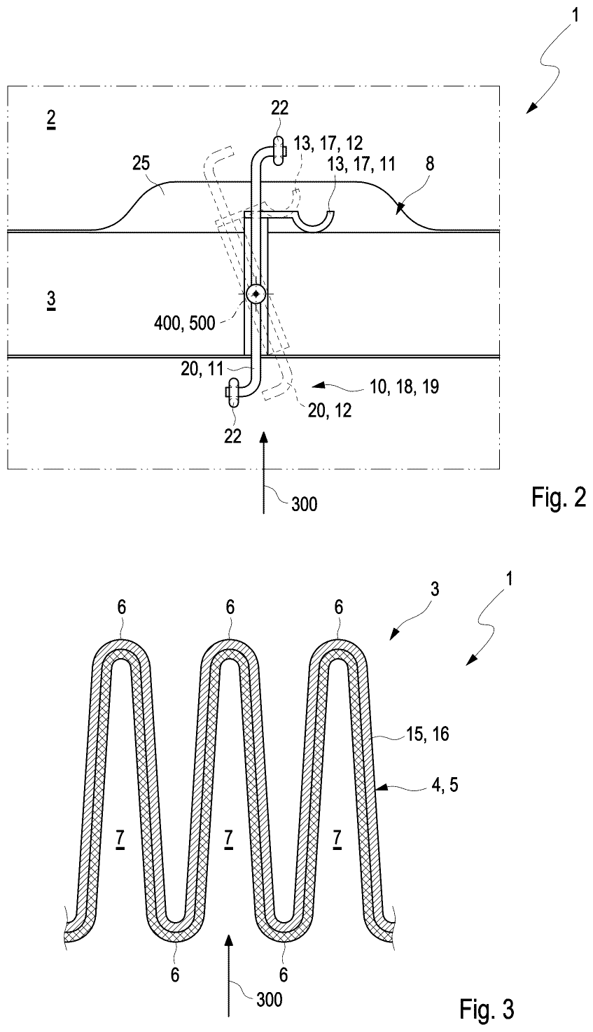

FIG. 2 shows a simplified, isometric illustration of the filter device, with a closure device;

FIG. 3 shows a cut through a filter element in the filter device;

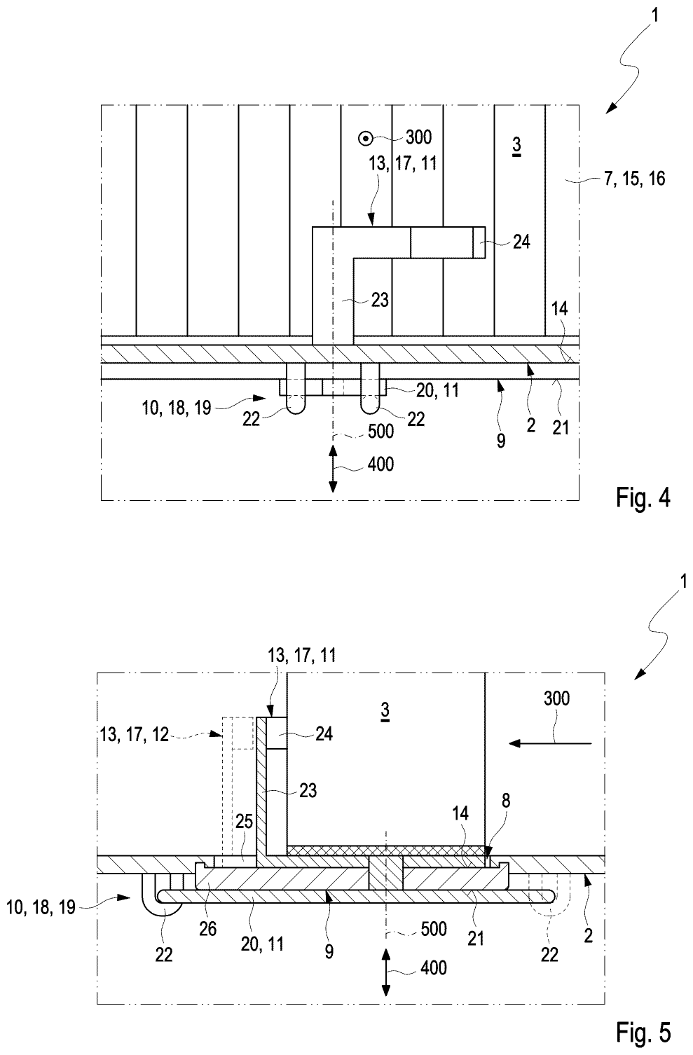

FIG. 4 shows a sectional view of the filter device; and

FIG. 5 shows another sectional view of the filter device.

A filter device 1 like that shown in FIGS. 1 to 5 is used to filter a fluid. The filter device 1 shown in the exemplary embodiments is used to filter air. The filter device 1 can, as shown in FIG. 1, be part of a filter system 100, which also contains an ionizer 101 for ionizing the air.

The filter device 1 shown in FIG. 1 has a section 2 through which air flows when in use, which is also referred to as a channel section 2. This channel section 2 is part of a channel 101 in the filter system 100 through which air flows when in use in these exemplary embodiments. This means that a flow path 300 conducts the air through the channel 101 and thus through the channel section 2. The filter device 1 contains a filter element 3 for filtering air in the channel section 2 and in the flow path 300. The air thus flows through the filter element 3 when in use, and is filtered. As shown only in FIG. 3, the filter element 3 contains a filter medium in the flow path 300 for filtering particles out of the air. The filter medium 4 in these exemplary embodiments can be electrostatically charged. The filter medium 4 in these exemplary embodiments is a pleated filter material 5 in the flow path 300. The filter medium 4 therefore has pleats 6, with gaps 7 between them.

An opening 8 is formed in the channel section 2, as shown in FIG. 1, for inserting and/or replacing the filter element 3, which is also referred to as the insertion opening 8. The filter element 3 is inserted in an insertion direction 400 though the insertion opening 8, into the channel section 2. The filter element 3 can thus be inserted in the insertion direction 400 through the insertion opening 8 into the channel section 2. A cover 9 for the filter device 1 closes the insertion opening 8. There is also a closure device 10 for the filter device 1, which can be seen in FIGS. 2, 4, and 5. This closure device 10 can be opened 11 or closed 12, as indicated by the broken lines in FIGS. 2 and 5. The closure device 10 secures the cover 9 in the closed state 11 on the channel section 2, such that the cover 9 closes the insertion opening 8. When opened 12, the closure device 10 releases the cover 9 from the channel section 2, such that the cover 9 can be removed from the insertion opening 8 to insert and/or replace the filter element 3.

The pleats 6, and therefore the gaps 7, in the filter medium 4 in these exemplary embodiments are transverse or angled in relation to the insertion direction 400, as indicated in FIG. 3. It can also be seen in FIG. 3 that there are a series of pleats 6 and gaps 7 in the filter medium 4, transverse to the insertion direction 400. This series of pleats 6 and gaps 7 in the filter medium is therefore transverse to the flow path 300.

The filter device 1 also contains an electrical conductor 13, which can be electrically connected to the filter element 3. The conductor 13 is on the inner surface 14 of the cover 9, facing the filter element 3 in the closed state 11 (see FIG. 5). The conductor 13 is also mechanically connected to the closure device 10 such that the conductor 13 comes in contact with the filter element 3, forming an electrical connection in the closed state 11, as indicated in FIGS. 1, 4 and 5, and is spaced apart from the filter element 3 in the opened state 12, such that the conductor 13 can be moved freely without damaging the filter medium 3.

The filter element 3 in these exemplary embodiments has an electrically conductive layer 15 applied to the filter medium 4, as shown in FIG. 4. This layer 15 is applied to the downstream side of the filter medium 4. This conductive layer 15 is made of activated carbon, thus forming an activated carbon layer 16. The conductor 13 comes in contact with the conductive layer 15, and is thus in contact with the filter element 3. In the opened state 12, the conductor 13 is spaced apart from the filter element 3, and thus from the conductive layer 15, such that the conductor can move freely without damaging the filter element 3.

The conductor 13 can have a spring 17. In these exemplary embodiments, the conductor 13 is such a spring 17. The conductor 13 is mechanically connected to the closure device 10 such that the spring 17 presses against the filter element 3 in the closed state 11. This pressure is at least reduced in the opened state 12. In particular, it exerts no pressure at all in the opened state 12.

The closure device 10 has a latching mechanism 18 in these exemplary embodiments, as shown in FIG. 2. In these exemplary embodiments, the closure device 10 is the latching mechanism 18. For purposes of clarity, the cover 9 is not shown in FIG. 2. This latching mechanism 18 is formed by a clip 19 in these exemplary embodiments. The latching mechanism 18 has a latching element 20 attached to the cover 9. In these exemplary embodiments, the latching element 20 is on an outer surface 21 of the cover 9 (see FIG. 5). The latching mechanism 18 also has at least one complementary latching element 22 on the channel section 2 (see FIG. 2). There are two such complementary latching elements 22 in the exemplary embodiments shown here. The latching element 20 and at least one complementary latching element 22 are engaged in the closed state 11. The latching element 20 and at least one complementary latching element 22 are disengaged in the opened state 12, indicated by the broken lines in FIG. 2. To open and close the latching mechanism, the latching element 20 pivots about a pivot axis 500, indicated in FIGS. 2, 4 and 5. This pivot axis 500 is parallel to the insertion direction 400 in these exemplary embodiments.

As FIGS. 4 and 5 show, the conductor 13 in these exemplary embodiments has a connecting section 23 parallel to the pivot axis 500, and a contact section 24 that is transverse and/or angled in relation to the connecting section 23. The contact section 24 of the conductor 13 comes in contact with the conductive layer 14 on the filter element 3 in the closed state 11, forming an electrical connection thereto. The contact section 24 of the conductor 13 is spaced apart from the filter element 3 along the flow path 300 in the opened state 12, and thus when placing and removing the cover on/from the insertion opening 8. When closed 11, the conductor 13 is moved toward the filter element 3, such that it comes in contact with the conductive layer 14 on the filter element 3.

The insertion opening 8 has an expansion 25 near the conductor 13, as shown in FIGS. 2 and 5, which extends laterally over the filter element 3 along the flow path 300 in the closed state 11. The expansion 25 allows the conductor 13 to be inserted in the insertion direction 400 through the expansion 25 into the channel section 2 at a spacing to the filter element, or removed therefrom. This prevents, or at least reduces, damage to the filter element 3 when it is inserted and/or replaced. The cover 9 has a shaped section 26 dedicated to the expansion 25 (see FIG. 5), such that it covers the entire insertion opening 8, including the expansion 25.

As FIG. 1 shows, the ionizer 101 in the channel 102 has an electrode assembly 103, that comprises an electrode 104 and a counter-electrode 105. The electrode 104 can be a discharge electrode. The electrode 104 has a negative polarity when in use, e.g. between-5 kV and-15 kV. The flow path 300 passes through the ionizer 101 upstream of the filter element 3. The counter-electrode 105 is upstream of the electrode 104 in the flow path 300 in this exemplary embodiment. Voltage from a power source 106 forms a corona discharge between the electrode 104 and the counter-electrode 105 when in use. As FIG. 1 shows, the filter element 3 in the filter system 100 is electrically connected with the same potential to the counter-electrode 105 by the conductor 13 in the closed state 11. This is obtained by an electrical connection of the filter element 3 to the power source 106 by the conductor 13, as indicated in FIG. 1.

The filter device 1, in particular the filter system 100, can be used in a motor vehicle 200, as indicated in FIG. 1. Air filtered by the filter device 1, in particular the filter system 100, can be supplied to the passenger compartment 201 in the motor vehicle 200. The flow path 300 thus flows downstream of the filter element 3 into the passenger compartment 201.

The specification can be readily understood with reference to the following Numbered Paragraphs:

Numbered Paragraph 1. A filter device (1) for filtering fluids, in particular air, which has
a channel section (2) through which a flow path (300) for the fluid passes,
a filter element (3) for filtering the fluid in the channel section (2) and flow path (300), wherein the filter element (3) contains a filter medium (4) for filtering particles out of the fluid in the flow path (3),
an insertion opening (8) formed in the channel section (2), through which the filter element (3) is inserted into the channel section (2) in an insertion direction (400),
a cover (9) for closing the insertion opening (8),
a closure device (10) that can be closed (11) and opened (12), wherein the closure device (10) secures the cover (9) on the channel section (2) in the closed state (11), such that the cover closes the insertion opening (8), wherein the closure device (10) releases the cover (9) from the channel section (2) in the opened state (12), such that the cover (9) can be removed from the insertion opening (8), wherein the cover (9) has an inner surface (14) facing the filter element (3) in the closed state (11),
an electrical conductor (13) on the inner surface (14) of the cover (9), which is mechanically coupled to the closure device (10), such that.
   the conductor (13) comes in contact with the filter element (3) in the closed state (11), thus forming an electrical connection,.
   the conductor (13) is spaced apart from the filter element (3) in the opened state (12), such that the conductor (13) can move freely in the insertion direction (400) without damaging the filter element (3).

Numbered Paragraph 2. The filter device according to Numbered Paragraph 1, characterized in that
the filter element (3) has an electrically conductive layer (15) applied to the filter medium (4),
the conductor (13) comes in contact with the layer (15) in the closed state (11) and is spaced apart from the layer (15) in the opened state (12), such that the conductor (15) can move freely in the insertion direction (400) without damaging the layer (15).

Numbered Paragraph 3. The filter device according to Numbered Paragraph 1 or 2, characterized in that
the conductor (13) has a spring (17), and in particular is a spring (17),
the closure device (10) is mechanically connected to the spring (17) such that the spring presses against the filter element (3) in the closed state (11), and exerts no pressure, or at least less, in the opened state (12).

Numbered Paragraph 4. The filter device according to any of the Numbered Paragraphs 1 to 3, characterized in that
the closure device (10) has a latching mechanism (18), in particular a clip (19), with a latching element (20) on the cover (9) and at least one complementary latching element (22) on the channel section (2), which latch together in the closed state (11) and are disengaged in the opened state (12),
the latching element (20) on the cover (9) can pivot about a pivot axis (500), such that the latching element (20) can be pivoted between the opened and closed states (11, 12) about the pivot axis (500)
the conductor (13) is mechanically connected to the latching element (20), such that the conductor (13) pivots when the latching element (20) is pivoted about the pivot axis (500).

Numbered Paragraph 5. The filter device according to Numbered Paragraph 4, characterized in that the pivot axis (500) is parallel to the insertion direction (400).

Numbered Paragraph 6. The filter device according to Numbered Paragraph 4 or 5, characterized in that the conductor (13) has a connecting section (23) parallel to the pivot axis (500) and connected to the latching element (20), and a contact section (24) that is transverse or angled in relation to the connecting section (23), and the conductor (13) comes in contact with the filter element (3) with its contact section (24) in the closed state (11).

Numbered Paragraph 7. The filter device according to any of the Numbered Paragraphs 1 to 6, characterized in that the insertion opening 8 has an expansion (25) extending laterally over the filter element 3, through which the conductor (13) is inserted into the channel section (2) in the insertion direction 400 in the opened state (8).

Numbered Paragraph 8. The filter device according to any of the Numbered Paragraphs 2 to 7, characterized in that the conductive layer (15) contains activated carbon, in particular forming an activated carbon layer (16).

Numbered Paragraph 9. The filter device according to any of the Numbered Paragraphs 2 to 8, characterized in that the conductive layer (15) is upstream of the filter medium (4).

Numbered Paragraph 10. A filter system (100) for filtering air, which has
a filter device (1) according to any of the preceding Numbered Paragraphs,
a channel (102) comprising the channel section (2) in the filter device (1),
an ionizer (101) containing an electrode assembly (103), in the flow path (300) upstream of the filter element (3),
wherein the electrode assembly (101) contains an electrode (104) and a counter-electrode (105), between which voltage forms a corona discharge in the air when in use,
wherein the filter element (3) is connected with the same potential to the counter electrode (105) by the conductor (13) in the closed state (11).

Numbered Paragraph 11. A motor vehicle (100) that has a filter device (1) according to any of the Numbered Paragraphs 1 to 9, in particular a filter system (100) according to Numbered Paragraph 10, and with a passenger compartment (201), wherein the flow path (300) leads into the passenger compartment (201) downstream of the filter element (3).*****

1-11. (canceled)

12. A filter device for filtering fluids, comprising
a channel section through which a flow path for a fluid passes,
a filter element for filtering the fluid in the channel section and flow path, wherein the filter element contains a filter medium for filtering particles out of the fluid in the flow path,
an insertion opening disposed in the channel section, through which the filter element is inserted into the channel section in an insertion direction,
a cover configured to close the insertion opening,
a closure device that can be disposed in a closed position and an open position, wherein the closure device is configured to secure the cover on the channel section in the closed position, such that the cover closes the insertion opening, wherein the closure device releases the cover from the channel section in the opened open position, such that the cover can be removed from the insertion opening, wherein the cover further comprises an inner surface facing the filter element in the closed state,
an electrical conductor disposed on the inner surface of the cover, the electrical conductor is mechanically coupled to the closure device, such that
the conductor comes in contact with the filter element when the closure device is in the closed position, thus forming an electrical connection,
the conductor is spaced apart from the filter element when the closure device is in the open position, such that the conductor can move freely in the insertion direction without damaging the filter element.

13. The filter device according to claim 12, wherein
the filter element has an electrically conductive layer applied to the filter medium,
the conductor comes in contact with the layer when the closure device is in the closed position and is spaced apart from the layer when the closure device is in the open position, such that the conductor can move freely in the insertion direction without damaging the layer.

14. The filter device according to claim 12, wherein
the conductor is a spring, and
the closure device is mechanically connected to the spring such that the spring presses against the filter element when the closure device is in the closed position, and the spring exerts less pressure against the filter element when the closure device is in the open position than the pressure that the spring exerts against the filter element when the closure device is in the open position.

15. The filter device according to claim 13, wherein
the closure device further comprises a latching mechanism, the latching mechanism comprises a latching element is disposed on the cover and at least one complementary latching element on the channel section, wherein the latching element upon the cover and the at least one complementary latching element on the channel section engage each other when the closure device is in the closed position and are disengaged when the closure device is in the open position,
the latching element on the cover is pivotable about a pivot axis, such that the latching element can be pivoted as the closure device moves about the pivot axis between the closed position and the open position
the conductor is mechanically connected to the latching element, such that the conductor pivots when the latching element is pivoted about the pivot axis.

16. The filter device according to claim 15, wherein the pivot axis is parallel to the insertion direction.

17. The filter device according to claim 15, wherein the conductor comprises a connecting section parallel to the pivot axis and connected to the latching element, and further comprises a contact section that is transverse or angled in relation to the connecting section, wherein the conductor comes in contact with the conductive layer on the filter element in the closed position.

18. The filter device according to claim 12, wherein the insertion opening comprises an expansion extending laterally over the filter element, through which the conductor is inserted into the channel section in the insertion direction.

19. The filter device according to claim 13, wherein the conductive layer contains activated carbon.

20. The filter device according to claim 13, wherein that the conductive layer is upstream of the filter medium.

21. A filter system for filtering air, comprising
a filter device according to claim 12,
a channel comprising the channel section in the filter device,
an ionizer comprising an electrode assembly, in the flow path upstream of the filter element,
wherein the electrode assembly comprises an electrode and a counter-electrode, wherein when in use a voltage between the electrode and counter electrode forms a corona discharge in the air,
wherein the filter element is connected with a same potential to the counter electrode by the conductor in the closed state.

22. A motor vehicle that has a filter system according to claim 21, and a passenger compartment, wherein the flow path leads into the passenger compartment downstream of the filter element.

23. The filter device of claim 14, wherein closure device is mechanically connected to the spring such that the spring exerts no pressure against the filter element when the closure device is in the open position.

24. The filter device of claim 15, wherein the latching mechanism is a clip.

25. The filter device of claim 19, wherein the conductive layer contains an activated carbon layer.
